(19) United States
(12) Patent Application Publication
(10) Pub. No.: US 2024/0162489 A1
(43) Pub. Date: May 16, 2024

(54) ELECTROLYTE FOR SECONDARY LITHIUM BATTERY AND SECONDARY LITHIUM BATTERY COMPRISING SAME

(71) Applicant: SAMSUNG SDI CO., LTD., Yongin-si, Gyeonggi-do (KR)

(72) Inventors: Tae Jin LEE, Yongin-si, Gyeonggi-do (KR); Soojin KIM, Yongin-si, Gyeonggi-do (KR); Suyeol RYU, Yongin-si, Gyeonggi-do (KR); Kyu-Eun SHIM, Yongin-si, Gyeonggi-do (KR); Junyong LEE, Yongin-si, Gyeonggi-do (KR); Wonseok CHO, Yongin-si, Gyeonggi-do (KR); Hyunbong CHOI, Yongin-si, Gyeonggi-do (KR); Jungmin HAN, Yongin-si, Gyeonggi-do (KR)

(21) Appl. No.: 17/768,341

(22) PCT Filed: Sep. 24, 2020
(86) PCT No.: PCT/KR2020/012948

§ 371 Date: Apr. 12, 2022

(30) Foreign Application Priority Data
Oct. 25, 2019 (KR) 10-2019-0133895

(51) Int. Cl. H01M 10/0567

(52) U.S. Cl. CPC H01M 10/0567; H01M 10/0525

(57) ABSTRACT

Provided is an electrolyte for a secondary lithium battery, comprising a non-aqueous organic solvent, a lithium salt, and an additive, the additive including a compound represented by Chemical Formula 1.

The details of Chemical Formula 1 are as described in the specification.

### TECHNICAL FIELD

An electrolyte for a secondary lithium battery and a secondary lithium battery including the same are disclosed.

### BACKGROUND ART

A lithium secondary battery may be recharged and has three or more times as high energy density per unit weight as a conventional lead storage battery, nickel-cadmium battery, nickel hydrogen battery, nickel zinc battery, and the like and may be also charged at a high rate and thus, is commercially manufactured for a laptop, a cell phone, an electric tool, an electric bike, and the like, and researches on improvement of additional energy density have been actively made.

Such a lithium secondary battery is manufactured by injecting an electrolyte into a battery cell, which includes a positive electrode including a positive active material capable of intercalating/deintercalating lithium ions and a negative electrode including a negative active material capable of intercalating/deintercalating lithium ions.

Particularly, an electrolyte includes an organic solvent in which a lithium salt is dissolved and critically determines stability and performance of a lithium secondary battery.

LiPF₆ that is most commonly used as a lithium salt of an electrolyte has a problem of reacting with an electrolytic solvent to promote depletion of a solvent and generate a large amount of gas. When LiPF₆ is decomposed, it generates LiF and PF₅, which leads to electrolyte depletion in the battery, resulting in degradation in high temperature performance and poor safety.

There are needs for an electrolyte which suppresses side reactions of such a lithium salt and improves the performance of the battery.

### DISCLOSURE

### Technical Problem

An embodiment provides an electrolyte for a lithium secondary battery capable of improving battery performance by ensuring high-temperature stability.

Another embodiment provides a lithium secondary battery including the electrolyte for a lithium secondary battery.

### Technical Solution

An embodiment of the present invention provides an electrolyte for a lithium secondary battery including a non-aqueous organic solvent, a lithium salt, and an additive, wherein the additive includes a compound represented by Chemical Formula 1.

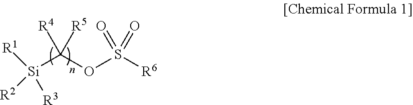

In Chemical Formula 1,
R¹ to R⁵ are each independently hydrogen, a halogen, a substituted or unsubstituted C1 to C10 alkyl group, a substituted or unsubstituted C1 to C10 alkoxy group, a substituted or unsubstituted C2 to C10 alkenyl group, a substituted or unsubstituted C3 to C10 cycloalkyl group, a substituted or unsubstituted C3 to C10 cycloalkenyl group, a substituted or unsubstituted C2 to C10 alkynyl group, a substituted or unsubstituted C3 to C10 cycloalkynyl group, or a substituted or unsubstituted C6 to C20 aryl group,
at least one of R¹ to R³ is a fluoro group (—F),
R⁶ is a substituted or unsubstituted C1 to C10 alkyl group, a substituted or unsubstituted C1 to C10 alkoxy group, a substituted or unsubstituted C2 to C10 alkenyl group, a substituted or unsubstituted C3 to C10 cycloalkyl group, a substituted or unsubstituted C3 to C10 cycloalkenyl group, a substituted or unsubstituted C2 to C10 alkynyl group, or a substituted or unsubstituted C3 to C10 cycloalkynyl group, and
n is an integer of any one of 1 to 20.

One or two of R¹ to R³ in Chemical Formula 1 may be a fluoro group (—F).

For example, it may be represented by Chemical Formula 1A.

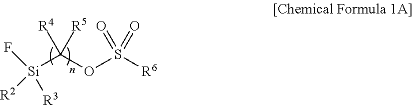

In Chemical Formula 1A,
definitions of R² to R⁶ and n are the same as described above.

For example, n in Chemical Formula 1 may be an integer of any one of 1 to 10.

As a specific example, n in Chemical Formula 1 may be an integer of any one of 1 to 5.

For example, Chemical Formula 1 may be represented by Chemical Formula 1A-1.

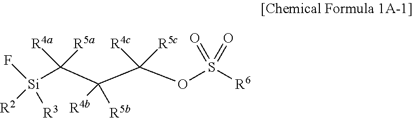

In Chemical Formula 1A-1,
definitions of R² to R⁶ and n are the same as described above.
R^{4a}, R^{4b}, R^{4c}, R^{5a}, R^{5b}, and R^{5c} may each independently be hydrogen, a halogen, a substituted or unsubstituted C1 to C10 alkyl group, a substituted or unsubstituted C1 to C10 alkoxy group, a substituted or unsubstituted C2 to C10 alkenyl group, a substituted or unsubstituted C3 to C10 cycloalkyl group, a substituted or unsubstituted C3 to C10 cycloalkenyl group, a substituted or unsubstituted C2 to C10 alkynyl group, a substituted or unsubstituted C3 to C10 cycloalkynyl group, or a substituted or unsubstituted C6 to C20 aryl group.

For example, in Chemical Formula 1, R¹ to R³ and R⁶ may each independently be a halogen, a substituted or unsubstituted C1 to C10 alkyl group, or a substituted or unsubstituted C2 to C5 alkenyl group, and any one of R¹ to R³ may be a fluoro group (—F).

The compound represented by Chemical Formula 1 may be included in an amount of 0.1 wt % to 10 wt % based on the total amount of the electrolyte for a lithium secondary battery.

The compound represented by Chemical Formula 1 may be included in an amount of 0.2 wt % to 2.0 wt % based on the total amount of the electrolyte for a lithium secondary battery.

Another embodiment of the present invention provides a lithium secondary battery including a positive electrode including a positive active material; a negative electrode including a negative active material; and the aforementioned electrolyte.

The negative active material may include a Si—C composite including a Si-based active material and a carbon-based active material.

The negative active material may further include crystalline carbon.

The crystalline carbon may include graphite, and the graphite may include natural graphite, artificial graphite, or a mixture thereof.

The Si—C composite may further include a shell surrounding the surface of the Si—C composite, and the shell may include amorphous carbon.

The amorphous carbon may include soft carbon, hard carbon, a mesophase pitch carbonized product, calcined coke, or a mixture thereof.

The positive active material may be a composite oxide of a nickel-containing metal and lithium.

The positive active material may be represented by Chemical Formula 5.

[Chemical Formula 5]

LiₐM¹_{1-y1-z1}M²_{y1}M³_{z1}O₂

In Chemical Formula 5,

0.9≤a≤1.8, 0≤y1≤1, 0≤z1≤1, 0≤y1+z1<1, and M¹, M², and M³ are each independently selected from a metal such as Ni, Co, Mn, Al, Sr, Mg, or La, and a combination thereof.

### Advantageous Effects

A lithium secondary battery with improved high-temperature stability and cycle-life characteristics may be implemented.

### DESCRIPTION OF THE DRAWINGS

FIG. 1 is a schematic view illustrating a lithium secondary battery according to an embodiment of the present invention.

FIG. 2 is a graph showing cycle-life characteristics at room temperature (25° C.) of secondary battery cells according to Examples 5 to 8 and Comparative Examples 6 to 10.

FIG. 3 is a graph showing an internal resistance increase rate of secondary battery cells according to Examples 5 to 8 and Comparative Examples 6 to 10 when allowed to stand at a high temperature.

FIG. 4 is a graph of measuring the CID (Current Interrupt Device) operation time of the secondary battery cells according to Examples 5 to 8 and Comparative Examples 6 to 10.

FIG. 5 is a graph showing cycle-life characteristics at room temperature (25° C.) of secondary battery cells according to Examples 1 to 4 and Comparative Examples 1 to 5.

FIG. 6 is a graph illustrating an internal resistance increase rate of secondary battery cells according to Examples 1 to 4 and Comparative Examples 1 to 5 when allowed to stand at a high temperature.

FIG. 7 is a graph of measuring the CID (Current Interrupt Device) operation time of the secondary battery cells according to Examples 1 to 4 and Comparative Examples 1 to 5.

### DESCRIPTION OF SYMBOLS

100: secondary lithium battery
112: negative electrode
113: separator
114: positive electrode
120: battery case
140: sealing member

### MODE FOR INVENTION

Hereinafter, embodiments of the present invention are described in detail. However, these embodiments are exemplary, the present invention is not limited thereto and the present invention is defined by the scope of claims.

In the present specification, when a definition is not otherwise provided, “substituted” refers to replacement of hydrogen of a compound by a substituent selected from a halogen atom (F, Br, Cl, or I), a hydroxy group, an alkoxy group, a nitro group, a cyano group, an amino group, an azido group, an amidino group, a hydrazino group, a hydrazono group, a carbonyl group, a carbamyl group, a thiol group, an ester group, a carboxyl group or a salt thereof, a sulfonic acid group or a salt thereof, a phosphoric acid group or a salt thereof, a C1 to C20 alkyl group, a C2 to C20 alkenyl group, a C2 to C20 alkynyl group, a C6 to C30 aryl group, a C7 to C30 arylalkyl group, a C1 to C4 alkoxy group, a C1 to C20 heteroalkyl group, a C3 to C20 heteroarylalkyl group, a C3 to C30 cycloalkyl group, a C3 to C15 cycloalkenyl group, a C6 to C15 cycloalkynyl group, a C2 to C20 heterocycloalkyl group, and a combination thereof.

Hereinafter, an electrolyte for a lithium secondary battery according to an embodiment is described.

An electrolyte for a lithium secondary battery according to an embodiment of the present invention includes a non-aqueous organic solvent, a lithium salt, and an additive, wherein the additive includes a compound represented by Chemical Formula 1.

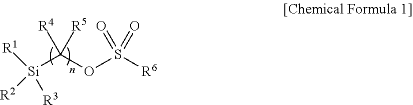

In Chemical Formula 1,
R¹ to R⁵ are each independently hydrogen, a halogen, a substituted or unsubstituted C1 to C10 alkyl group, a substituted or unsubstituted C1 to C10 alkoxy group, a substituted or unsubstituted C2 to C10 alkenyl group, a substituted or unsubstituted C3 to C10 cycloalkyl group, a substituted or unsubstituted C3 to C10 cycloalkenyl group, a substituted or unsubstituted C2 to C10 alkynyl group, a substituted or unsubstituted C3 to C10 cycloalkynyl group, or a substituted or unsubstituted C6 to C20 aryl group,
at least one of R¹ to R³ is a fluoro group (—F),
R⁶ is a substituted or unsubstituted C1 to C10 alkyl group, a substituted or unsubstituted C1 to C10 alkoxy group, a substituted or unsubstituted C2 to C10 alkenyl group, a substituted or unsubstituted C3 to C10 cycloalkyl group, a substituted or unsubstituted C3 to C10 cycloalkenyl group, a substituted or unsubstituted C2 to C10 alkynyl group, or a substituted or unsubstituted C3 to C10 cycloalkynyl group, and
n is an integer of any one of 1 to 20.

Meanwhile, when n is an integer of 2 or more, at least two R⁴'s or at least two R⁵'s may be the same or different.

The compound represented by Chemical Formula 1 included in the additive according to an embodiment of the present invention includes a silyl functional group substituted with a sulfite group (—SO₃—) and at least one fluoro group in one molecule.

These are decomposed into lithium salts in the electrolyte to form films on the surfaces of the positive and negative electrodes, respectively, thereby reducing initial resistance, suppressing a high-temperature storage resistance increase rate, and reducing gas generation.

Specifically, LiSO₃R⁶⁺, a lithium salt including a sulfite-based functional group, migrate to the negative electrode and thus is reduced and decomposed on the surface of the negative electrode and may form an excellent SEI (solid electrolyte interphase) film having excellent ion conductivity as well as being strong on the negative electrode surface, and accordingly, the formation of the initial SEI film may suppress decomposition of the negative electrode surface which may occur during the high-temperature cycle operation, and in addition, the initially-formed SEI film which may occur at the high-temperature storage may be prevented from collapse. In addition, sulfite may also form a film on the positive electrode surface and thus prevent oxidation of the electrolyte at the positive electrode and thus reduce a resistance increase rate in the secondary lithium battery.

In addition, F⁻ may form SEI including LiF with strong adherence during initial reduction of the electrolyte on the negative electrode surface and thereby, reduce a volume expansion degree of the negative electrode including Si. Accordingly, the secondary lithium battery to which the negative electrode including Si is applied may exhibit an effect of reducing an amount of gas generated during the high-temperature storage as well as an effect of improving a long-term cycle-life.

For example, one or two of R¹ to R³ in Chemical Formula 1 may be a fluoro group (—F).

When the number of substituted fluoro groups is maintained at a maximum of two, an amount of gas generated during high-temperature storage may be minimized.

For example, one of R¹ to R³ of Chemical Formula 1 may be a fluoro group (—F) and may be, for example, represented by Chemical Formula 1A.

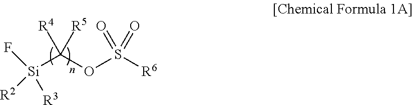

In Chemical Formula 1A,
definitions of R² to R⁶ and n are the same as described above.

For example, n in Chemical Formula 1 may be an integer of any one of 1 to 10.

As a specific example, n in Chemical Formula 1 may be an integer of any one of 1 to 5.

As a more specific example, n in Chemical Formula 1 may be an integer of any one of 2 to 5.

For example, n in Chemical Formula 1 may be an integer of 3, and may be represented by Chemical Formula 1A-1.

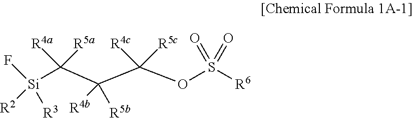

In Chemical Formula 1A-1,
definitions of R² to R⁶ and n are the same as described above, and
R^{4a}, R^{4b}, R^{4c}, R^{5a}, R^{5b}, and R^{5c} may each independently be hydrogen, a halogen, a substituted or unsubstituted C1 to C10 alkyl group, a substituted or unsubstituted C1 to C10 alkoxy group, a substituted or unsubstituted C2 to C10 alkenyl group, a substituted or unsubstituted C3 to C10 cycloalkyl group, a substituted or unsubstituted C3 to C10 cycloalkenyl group, a substituted or unsubstituted C2 to C10 alkynyl group, a substituted or unsubstituted C3 to C10 cycloalkynyl group, or a substituted or unsubstituted C6 to C20 aryl group.

For example, in Chemical Formula 1, R¹ to R³ and R⁶ may each independently be a halogen, a substituted or unsubstituted C1 to C10 alkyl group, or a substituted or unsubstituted C2 to C5 alkenyl group, and any one of R¹ to R³ may be a fluoro group (—F).

As a specific example, in Chemical Formula 1, R¹ to R³ and R⁶ may each independently be a halogen or a substituted or unsubstituted C1 to C10 alkyl group, and any one of R¹ to R³ may be a fluoro group (—F).

In addition, as an example, R⁴ and R⁵ in Chemical Formula 1 may each independently be hydrogen, a substituted or unsubstituted C1 to C10 alkyl group, or a substituted or unsubstituted C2 to C10 alkenyl group.

As a specific example, each of R⁴ and R⁵ in Chemical Formula 1 may be hydrogen or at least one may be a C1 to C5 alkyl group, but is not limited thereto.

The compound represented by Chemical Formula 1 may be included in an amount of 0.1 wt % to 10 wt %, specifically 0.1 wt % to 5.0 wt %, or more specifically 0.2 wt % to 2.0 wt %, based on the total amount of the electrolyte for a lithium secondary battery.

When the content range of the compound represented by Chemical Formula 1 is as described above, a lithium secondary battery having improved cycle-life characteristics may be implemented by preventing an increase in resistance at high temperatures and suppressing gas generation.

That is, when the content of the compound represented by Formula 1 is less than 0.1 wt %, high-temperature storage characteristics may be lowered, while when it exceeds 10 wt %, cycle-life may be reduced due to an increase in interfacial resistance.

The non-aqueous organic solvent serves as a medium for transmitting ions taking part in the electrochemical reaction of a battery.

The non-aqueous organic solvent may include a carbonate-based, ester-based, ether-based, ketone-based, alcohol-based, or aprotic solvent.

The carbonate-based solvent may be dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like. The ester-based solvent may be methyl acetate, ethyl acetate, n-propyl acetate, t-butyl acetate, methylpropionate, ethylpropionate, propylpropionate, decanolide, mevalonolactone, caprolactone, and the like. The ether-based solvent may be dibutyl ether, tetraglyme, diglyme, dimethoxyethane, 2-methyltetrahydrofuran, tetrahydrofuran, and the like. In addition, the ketone-based solvent may be cyclohexanone, and the like. In addition, the alcohol-based solvent may be ethyl alcohol, isopropyl alcohol, and the like and the aprotic solvent may be nitriles such as R—CN is a C2 to C20 linear, branched, or cyclic hydrocarbon group and may include aromatic ring having a double bond, or an ether bond, amides such as dimethylformamide, dioxolanes such as 1,3-dioxolane, sulfolanes, and the like.

The non-aqueous organic solvent may be used alone or in a mixture and when the organic solvent is used in a mixture, the mixture ratio may be controlled in accordance with a desirable battery performance.

The carbonate-based solvent is prepared by mixing a cyclic carbonate and a chain carbonate. In this case, when the cyclic carbonate and the chain carbonate are mixed in a volume ratio of 1:1 to 1:9, the performance of the electrolyte may be improved.

The non-aqueous organic solvent may further include an aromatic hydrocarbon-based organic solvent in the carbonate-based solvent. In this case, the carbonate-based solvent and the aromatic hydrocarbon-based solvent may be mixed in a volume ratio of 1:1 to 30:1.

As the aromatic hydrocarbon-based solvent, an aromatic hydrocarbon-based compound represented by Chemical Formula 3 may be used.

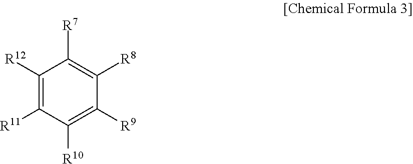

In Chemical Formula 3, R⁷ to R¹² are the same or different and are selected from hydrogen, a halogen, a C1 to C10 alkyl group, a haloalkyl group, and a combination thereof.

Specific examples of the aromatic hydrocarbon-based solvent may be selected from benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and a combination thereof.

In order to improve cycle-life of the battery, the electrolyte may further include vinylene carbonate or an ethylene-based carbonate-based compound represented by Chemical Formula 4 as a cycle-life improving additive in order to improve battery cycle-life.

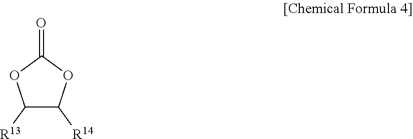

In Chemical Formula 4, R¹³ and R¹⁴ are the same or different, and selected from hydrogen, a halogen, a cyano group (CN), a nitro group (NO₂), and fluorinated C1 to C5 alkyl group provided that at least one of R¹³ and R¹⁴ is a halogen, a cyano group (CN), a nitro group (NO₂), and a fluorinated C1 to C5 alkyl group, and both of R¹³ and R¹⁴ are not hydrogen.

Examples of the ethylene-based carbonate-based compound may be difluoro ethylenecarbonate, chloroethylene carbonate, dichloroethylene carbonate, bromoethylene carbonate, dibromoethylene carbonate, nitroethylene carbonate, cyanoethylene carbonate, or fluoroethylene carbonate. The amount of the additive for improving cycle-life may be used within an appropriate range.

The lithium salt is dissolved in a non-aqueous organic solvent, supplies a battery with lithium ions, basically operates the lithium secondary battery, and improves transportation of the lithium ions between positive and negative electrodes. Examples of the lithium salt include one or more selected from LiPF₆, LiBF₄, LiSbF₆, LiAsF₆, LiN(SO₂C₂F₅)₂, Li(CF₃SO₂)₂N, LiN(SO₃C₂F₅)₂, Li(FSO₂)₂N (lithium bis(fluorosulfonyl)imide: LiFSI), LiC₄F₉SO₃, LiClO₄, LiAlO₂, LiAlCl₄, LiN(CₓF₂ₓ₊₁SO₂)(C_{y}F_{2y+1}SO₂), wherein, x and y are natural numbers, for example an integer of 1 to 20, LiCl, LiCl, LiI, and LiB(C₂O₄)₂ (lithium bis(oxalato) borate: LiBOB). The lithium salt may be used in a concentration ranging from 0.1 M to 2.0 M. When the lithium salt is included at the above concentration range, an electrolyte may have excellent performance and lithium ion mobility due to optimal electrolyte conductivity and viscosity.

Another embodiment of the present invention provides a lithium secondary battery including a positive electrode including a positive active material; a negative electrode including a negative active material; and the aforementioned electrolyte.

The positive electrode may include a current collector and a positive active material layer including a positive active material which is formed on the current collector. The positive active material may include lithiated intercalation compounds that reversibly intercalate and deintercalate lithium ions.

Specifically, a composite oxide of a nickel-containing metal and lithium may be used.

Specific examples thereof may be a compound represented by one of chemical formulas.

LiₐA_{1-b}X_{b}D₂ (0.90≤a≤1.8, 0≤b≤0.5); LiₐA_{1-b}X_{b}O_{2-c}D_{c} (0.90≤a≤1.8, 0≤b≤0.5, 0≤c≤0.05); LiₐE_{1-b}X_{b}O_{2-c}D_{c} (0.90≤a≤1.8, 0≤b≤0.5, 0≤c≤0.05); LiₐE_{2-b}X_{b}O_{4-c}D_{c} (0.90≤a ≤1.8, 0≤b≤0.5, 0<c≤0.05); LiₐNi_{1-b-c}Co_{b}X_{c}D_{α}(0.90≤a≤1.8, 0≤b≤0.5, 0≤c≤0.5, 0<α≤2); LiₐNi_{1-b-c}Co_{b}X_{c}O_{2-α}T_{α}(0.90≤a≤1.8, 0≤b≤0.5, 0≤c≤0.05, 0<α<2); LiₐNi_{1-b-c}Co_{b}X_{c}O_{2-α}T₂ (0.90≤a≤1.8, 0≤b≤0.5, 0≤c≤0.05, 0<α<2); LiₐNi_{1-b-c}Mn_{b}X_{c}D_{α}(0.90≤a≤1.8, 0≤b≤0.5, 0≤c≤0.05, 0<α≤2); LiₐNi_{1-b-c}Mn_{b}X_{c}O_{2-α}T_{α}(0.90≤a≤1.8, 0≤b ≤0.5, 0≤c≤0.05, 0<α<2); LiₐNi_{1-b-c}Mn_{b}X_{c}O_{2-α}T₂ (0.90≤a≤1.8, 0≤b≤0.5, 0≤c≤0.05, 0<α<2); LiₐNi_{b}E_{c}G_{d}O₂ (0.90≤a≤1.8, 0≤b≤0.9, 0≤c≤0.5, 0.001≤d≤0.1); LiₐNi_{b}Co_{c}Mn_{d}GₑO₂ (0.90≤a≤1.8, 0≤b≤0.9, 0≤c≤0.5, 0≤d≤0.5, 0.001≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); QO₂; QS₂; LiQS₂; V₂O₅; LiV₂O₅; LiZO₂; LiNiVO₄; Li_{(3-f)}J₂(PO₄)₃ (0≤f≤2); Li_{(3-f)}Fe₂(PO₄)₃ (0≤f≤2); LiₐFePO₄ (0.90≤a≤1.8)

In chemical formulas, A is selected from Ni, Co, Mn, and a combination thereof; X is selected from Al, Ni, Co, Mn, Cr, Fe, Mg, Sr, V, a rare earth element, and a combination thereof; D is selected from O, F, S, P, and a combination thereof; E is selected from Co, Mn, and a combination thereof; T is selected from F, S, P, and a combination thereof; G is selected from Al, Cr, Mn, Fe, Mg, La, Ce, Sr, V, and a combination thereof; Q is selected from Ti, Mo, Mn, and a combination thereof; Z is selected from Cr, V, Fe, Sc, Y, and a combination thereof; and J is selected from V, Cr, Mn, Co, Ni, Cu, and a combination thereof.

The positive active material may include the positive active material with the coating layer, or a compound of the positive active material and the positive active material coated with the coating layer. The coating layer may include a coating element compound of an oxide or hydroxide of a coating element, oxyhydroxide of a coating element, oxycarbonate of a coating element, or hydroxycarbonate of a coating element. The compound for the coating layer may be either amorphous or crystalline. The coating element included in the coating layer may be Mg, Al, Co, K, Na, Ca, Si, Ti, V, Sn, Ge, Ga, B, As, Zr, or a mixture thereof. The coating process may include any conventional processes as long as it does not cause any side effects on the properties of the positive active material (e.g., spray coating or dipping), which is a content that can be well understood by those engaged in the relevant field and thus a detailed description will be omitted.

More specifically, at least one type of lithium composite oxide represented by Chemical Formula 5 may be used.

[Chemical Formula 5]

LiₐM¹_{1-y1-z1}M²_{y1}M³_{z1}O₂

In Chemical Formula 5,

0.9≤a≤1.8, 0≤y1≤1, 0≤z1≤1, 0≤y1+z1<1, and M¹, M², and M³ are each independently selected from a metal such as Ni, Co, Mn, Al, Sr, Mg, or La, and a combination thereof.

For example, M¹ may be Ni, and M² and M³ may each independently be a metal such as Co, Mn, Al, Sr, Mg, or La.

More specifically, M¹ may be Ni, M² may be Co, and M³ may be Mn or Al, but are not limited thereto.

Specific examples of the positive active material according to the embodiment of the present invention include LiₓNi_{y}Co_{z}Al_{1-y-z}O₂ (1≤x≤1.2, 0.5≤y≤1, and 0≤z≤0.5).

The content of the positive active material may be 90 wt % to 98 wt % based on the total weight of the positive active material layer.

In an embodiment, the positive active material layer may include a binder and a conductive material. Herein, each amount of the binder and conductive material may be 1 wt % to 5 wt % based on the total weight of the positive active material layer.

The binder improves binding properties of positive active material particles with one another and with a current collector examples thereof and may for example include polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but is not limited thereto.

The conductive material is included to improve electrode conductivity and any electrically conductive material may be used as a conductive material unless it causes a chemical change and examples of the conductive material include a carbon-based material such as natural graphite, artificial graphite, carbon black, acetylene black, ketjen black, a carbon fiber, and the like; a metal-based material of a metal powder or a metal fiber including copper, nickel, aluminum, silver, and the like; a conductive polymer such as a polyphenylene derivative; or a mixture thereof.

The current collector may be Al, but is not limited thereto.

The negative electrode includes a current collector and a negative active material layer formed on the current collector.

The negative active material may be a material that reversibly intercalates/deintercalates lithium ions, a lithium metal, a lithium metal alloy, a material capable of doping and dedoping lithium, or a transition metal oxide.

The material that reversibly intercalates/deintercalates lithium ions includes carbon materials and the carbon material may be any generally-used carbon-based negative active material in a lithium ion secondary battery and examples of the carbon material include crystalline carbon, amorphous carbon, and a combination thereof. The crystalline carbon may be non-shaped, or sheet, flake, spherical, or fiber shaped natural graphite or artificial graphite and the amorphous carbon may be a soft carbon, a hard carbon, a mesophase pitch carbonized product, calcined coke, and the like.

The lithium metal alloy may include lithium and a metal selected from Na, K, Rb, Cs, Fr, Be, Mg, Ca, Sr, Si, Sb, Pb, In, Zn, Ba, Ra, Ge, Al, and Sn.

The material capable of doping and dedoping lithium may include Si, SiOₓ (0<x<2), a Si-Q alloy (wherein Q is selected from an alkali metal, an alkaline-earth metal, a Group 13 element, a Group 14 element, a Group 15 element, a Group 16 element, a transition metal, a rare earth element, and a combination thereof, and not Si), Sn, SnO₂, a Sn—R alloy (wherein R is an alkali metal, an alkaline-earth metal, a Group 13 element, a Group 14 element, a Group 15 element, a Group 16 element, a transition element, a rare earth element, or a combination thereof, and not Sn), and the like and at least one of them may be mixed with SiO₂. The elements Q and R may be selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, and combination thereof.

The transition metal oxide may be a vanadium oxide, a lithium vanadium oxide, and the like.

The negative active material according to an embodiment may include a Si—C composite including a Si-based active material and a carbon-based active material.

The Si-based active material may have an average particle diameter of 50 nm to 200 nm.

When the Si-based active material has an average particle diameter within the range, the volume expansion occurring during the charge and discharge may be suppressed, and disconnection of conductive paths by particles crushed during the charge and discharge may be prevented.

The Si-based active material may be included in an amount of 1 wt % to 60 wt %, or for example, 3 wt % to 60 wt % based on the total weight of the Si—C composite.

According to another example embodiment, the negative active material may further include crystalline carbon along with the Si—C composite.

When the negative active material includes the Si—C composite and the crystalline carbon together, the Si—C composite and the crystalline carbon may be included in the form of a mixture, and in this case, the Si—C composite and the crystalline carbon may be included in a weight ratio of 1:99 to 50:50. More specifically, the Si—C composite and the crystalline carbon may be included in a weight ratio of 5:95 to 20:80.

The crystalline carbon may include, for example, graphite, and more specifically, natural graphite, artificial graphite, or a mixture thereof.

An average particle diameter of the crystalline carbon may be 5 μm to 30 μm.

In the present specification, an average particle diameter may be particle size (D₅₀) at a volume ratio of 50% in a cumulative size-distribution curve.

The Si—C composite may further include a shell surrounding the surface of the Si—C composite, and the shell may include amorphous carbon.

The amorphous carbon may include soft carbon, hard carbon, a mesophase pitch carbonized product, calcined coke, or a mixture thereof.

The amorphous carbon may be included in an amount of 1 part by weight to 50 parts by weight, for example, 5 to 50 parts by weight, or 10 to 50 parts by weight based on 100 parts by weight of the carbon-based active material.

In the negative active material layer, the negative active material may be included in an amount of 95 wt % to 99 wt % based on the total weight of the negative active material layer.

In an embodiment, the negative active material layer may include a binder, and optionally a conductive material. In the negative active material layer, the amount of the binder may be 1 wt % to 5 wt % based on the total weight of the negative active material layer. When it further includes the conductive material, it may include 90 wt % to 98 wt % of the negative active material, 1 wt % to 5 wt % of the binder, and 1 wt % to 5 wt % of the conductive material.

The binder improves binding properties of negative active material particles with one another and with a current collector. The binder may be a non-water-soluble binder, a water-soluble binder, or a combination thereof.

The non-water-soluble binder may be polyvinylchloride, carboxylated polyvinylchloride, polyvinylfluoride, polyurethane, polytetrafluoroethylene, polyvinylidene fluoride, polyethylene, polypropylene, polyamideimide, polyimide, or a combination thereof.

The water-soluble binder may be a rubber-based binder or a polymer resin binder. The rubber-based binder may be selected from a styrene-butadiene rubber, an acrylated styrene-butadiene rubber (SBR), an acrylonitrile-butadiene rubber, an acrylic rubber, a butyl rubber, a fluorine rubber, and a combination thereof. The polymer resin binder may be selected from polytetrafluoroethylene, an ethylenepropylene copolymer, polyethyleneoxide, polyvinylpyrrolidone, polyepichlorohydrine, polyphosphazene, polyacrylonitrile, polystyrene, ethylenepropylenedienecopolymer, polyvinylpyridine, chlorosulfonatedpolyethylene, latex, a polyester resin, an acrylic resin, a phenolic resin, an epoxy resin, polyvinyl alcohol, and a combination thereof.

When the water-soluble binder is used as the negative electrode binder, a cellulose-based compound may be further used to provide viscosity. The cellulose-based compound includes one or more of carboxylmethyl cellulose, hydroxypropylmethyl cellulose, methyl cellulose, or alkali metal salts thereof. The alkali metal may be Na, K, or Li. Such a thickener may be included in an amount of 0.1 to 3 parts by weight based on 100 parts by weight of the negative active material.

The conductive material is included to provide electrode conductivity and any electrically conductive material may be used as a conductive material unless it causes a chemical change and examples thereof may be a carbon-based material such as natural graphite, artificial graphite, carbon black, acetylene black, ketjen black, a carbon fiber and the like; a metal-based material such as a metal powder or a metal fiber and the like of copper, nickel, aluminum, silver, and the like; a conductive polymer such as a polyphenylene derivative and the like, or a mixture thereof.

The current collector may be selected from a copper foil, a nickel foil, a stainless steel foil, a titanium foil, a nickel foam, a copper foam, a polymer substrate coated with a conductive metal, and a combination thereof.

A separator may be present between the positive electrode and the negative electrode depending on a type of the lithium secondary battery. Such a separator may include polyethylene, polypropylene, polyvinylidene fluoride, or a multilayer film of two or more layers thereof such as a polyethylene/polypropylene double-layered separator, a polyethylene/polypropylene/polyethylene triple-layered separator, and a polypropylene/polyethylene/polypropylene triple-layered separator.

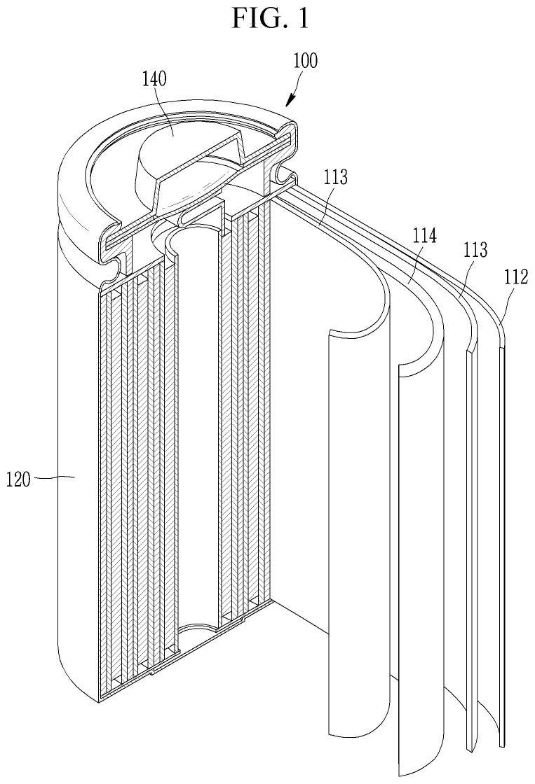

Referring to FIG. 1, a lithium secondary battery 100 according to an embodiment includes a battery cell including a negative electrode 112, a positive electrode 114 facing the negative electrode 112, a separator 113 interposed between the negative electrode 112 and the positive electrode 114, and an electrolyte (not shown) impregnating the negative electrode 112, the positive electrode 114, and the separator 113, a battery case 120 configured to accommodate the battery cell, and a sealing member 140 sealing the battery case 120.

Hereinafter, examples of the present invention and comparative examples are described. These examples, however, are not in any sense to be interpreted as limiting the scope of the invention.

### MANUFACTURE OF LITHIUM SECONDARY BATTERY CELLS

### Preparation Example: Synthesis of Compound Represented by Chemical Formula a

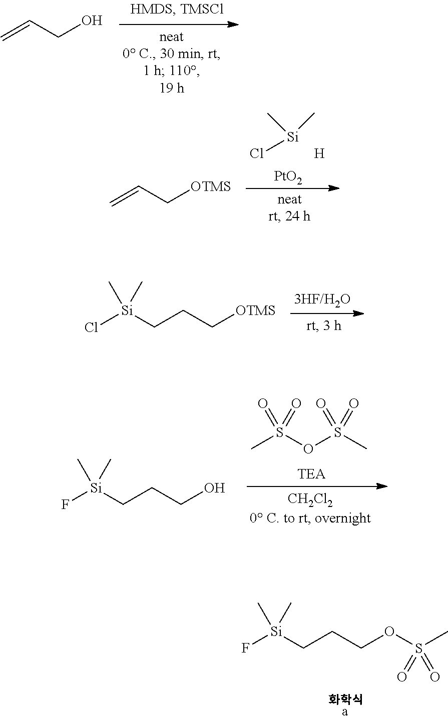

### 1^{st} Step: Synthesis of Allyloxytrimethylsilane

After heat-drying a flask, allyl alcohol (1.0 eq) and trimethylsilylchloride (0.1 eq) were put therein and stirred under a nitrogen atmosphere. Subsequently, hexamethyldisilazane (0.5 eq) was slowly added thereto in a dropwise fashion at 0° C. When the dropwise addition was completed, after stirring the mixture for 1 hour and then, attaching a reflux cooler to the flask, the flask was heated at 110° C. for 19 hours. The resultant was purified through simple distillation, obtaining allyloxytrimethylsilane.

bp=97-99° C./760 mmHg;

¹H NMR (400 MHz, CDCl₃): δ 5.94 (m, 1H), 5.25 (d, 1H), 5.10 (d, 1H), 4.14 (d, 1H), 0.15 (s, 9H)

### 2^{nd} Step: Synthesis of 3-(chlorodimethylsilyl)propoxy]trimethylsilane

After heat-drying a flask, platinum oxide (10 mg to 40 mg) and allyloxytrimethylsilane (1.0 eq) were put therein and stirred. Subsequently, dimethylchlorosilane was slowly added in a dropwise fashion thereto in as much as to react with all the allyloxytrimethylsilane in a range of 1.2 eq to 2.0 eq at 0° C. When the dropwise addition was completed, the reaction was monitored through ¹H NMR until the allyloxytrimethylsilane was all consumed. When the consumption of the allyloxytrimethylsilane was confirmed, the catalyst was removed with a celite pad, and an excessive amount of the dimethylchlorosilane was removed through a pressure reducer, obtaining a yellowish opaque liquid. This liquid might be purified through distillation but since other materials were known to be produced during the purification, the following reaction was performed without the purification.

¹H NMR (400 MHz, CDCl3): δ 3.56 (t, 2H), 1.67-1.59 (m, 2H), 0.84-0.79 (m, 2H), 0.41 (s, 6H), 0.11 (s, 9H)

### 3^{rd} Step: Synthesis of 3-(fluorodimethylsilyl)-1-propanol

3-[(chlorodimethylsilyl)propoxy]trimethylsilane was put in a TEFLON (tetrafluoroethylene) tube, an excessive amount of HF (48 wt %) was added thereto and then, stirred for 3 hours or so, and a reaction was monitored through ¹H NMR. A solution obtained therefrom was several times washed with sodium bicarbonate and distilled water, dried with MgSO₄, and filtered, obtaining a yellow transparent liquid. This liquid was purified through distillation under a reduced pressure, obtaining 3-(fluorodimethylsilyl)-1-propanol as a colorless and transparent liquid.

bp=71° C. (10 torr);

¹H NMR (400 MHz, CDCl₃): δ 3.62 (t, 2H), 1.65 (m, 2H), 1.57 (s, 1H), 0.72 (m, 2H)

### 4^{th} Step: 3-(fluorodimethylsilyl)-1-propyl methanesulfonate

After putting a molecular sieve in a heat-dried flask, 3-(fluorodimethylsilyl)-1-propanol (1.0 eq) and triethylamine (1.2 eq) were put therein under an argon atmosphere and stirred for 10 minutes. Subsequently, methanesulfonic anhydride (1.2 eq) was dissolved in dichloromethane and then, added in a dropwise fashion to the flask in ice water. The obtained solution was several times washed with distilled water, dried with MgSO₄, and purified through distillation under a reduced pressure, obtaining 3-(fluorodimethylsilyl)-1-propyl methanesulfonate.

bp=88° C. (0.1 Torr);

¹H NMR (400 MHz, CDCl3): δ 4.20 (t, 2H), 3.08 (s, 3H), 1.89-1.81 (m, 2H), 0.78-0.72 (m, 2H), 0.27-0.23 (m, 6H)

### Comparative Preparation Example: Synthesis of Compound Represented by Chemical Formula b

### Synthesis of 3-(fluorodimethylsilyl)propyl methanesulfonate:

After putting a molecular sieve in a heat-dried flask, 3-(trimethylsilyl)-1-propanol (1.0 eq) and triethylamine (1.2 eq) were put therein under an argon atmosphere and stirred for 10 minutes. Subsequently, methanesulfonic anhydride (1.2 eq) dissolved dichloromethane was added in a dropwise fashion to the flask in ice water. The obtained solution was several times washed with distilled water, dried with MgSO₄, and purified through distillation under a reduced pressure, obtaining 3-(fluorodimethylsilyl)-1-propyl methanesulfonate.

bp=111° C. (96 mmHg);

¹H NMR (400 MHz, CDCl3): δ 4.35 (t, 2H), 3.12 (s, 3H), 1.85 (m, 2H), 0.81 (m, 2H), 0.17 (m, 9H)

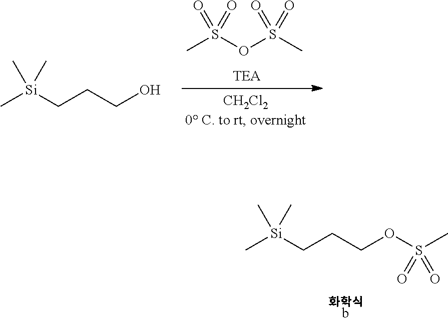

### Example 1

LiNi_{0.88}Co_{0.105}Al_{0.015}O₂ as a positive active material, polyvinylidene fluoride as a binder, and carbon black as a conductive material were mixed respectively in a weight ratio of 97:1.6:1.4 and then, dispersed in N-methyl pyrrolidone to prepare positive active material slurry.

The positive active material slurry was coated on a 20 μm-thick Al foil, dried at 100° C., and pressed to manufacture a positive electrode.

On the other hand, a mixture of graphite and Si—C composite in a weight ratio of 89:11 as a negative active material, a styrene-butadiene rubber binder, and carboxylmethyl cellulose were mixed in a weight ratio of 98:1:1 and dispersed in distilled water, preparing negative active material slurry.

The Si—C composite had a core including artificial graphite and silicon particles and coal pitch coated on the surface of the core, wherein an amount of the silicon particles was about 3 wt % based on the total weight of the Si—C composite.

The negative active material slurry was coated on a 10 μm-thick Cu foil, dried at 100° C., and pressed to manufacture a negative electrode.

The manufactured positive and negative electrodes, a 25 μm-thick polyethylene separator, and an electrolyte were used to manufacture a lithium secondary battery cell.

A composition of the electrolyte is as follows.

### Composition of the Electrolyte

Salt: LiPF₆ 1.5 M
Solvent: ethylene carbonate: ethylmethyl carbonate:dimethyl carbonate (EC:EMC:DMC=volume ratio of 2:1:7)+7 wt % of fluoroethylene carbonate
Additive: 0.5 wt % of compound represented by Chemical Formula a

(Herein, the composition of the electrolyte, “wt %” is based on the total amount (lithium salt+non-aqueous organic solvent+additive) of the electrolyte)

### Example 2

A lithium secondary battery cell was manufactured in the same manner as Example 1 except that the amount of the additive was changed to 2.0 wt %.

### Example 3

A lithium secondary battery cell was manufactured in the same manner as Example 1 except that the amount of the additive was changed to 1.0 wt %.

### Example 4

A lithium secondary battery cell was manufactured in the same manner as Example 1 except that the amount of the additive was changed to 0.2 wt %.

### Examples 5 to 8

Lithium secondary battery cells were manufactured in the same manner as in Examples 1 to 4, respectively, except that the negative active material was changed to 100 wt % of crystalline graphite.

### Comparative Example 1

A lithium secondary battery cell was manufactured in the same manner as in Example 1, except that additives were not used.

### Comparative Examples 2 to 5

Lithium secondary battery cells were manufactured in the same manner as in Examples 1 to 4 respectively, except that the additive is changed to the compound represented by Chemical Formula b according to Comparative Preparation Example.

### Comparative Example 6

A lithium secondary battery cell was manufactured in the same manner as in Example 5, except that additives were not used.

### Comparative Examples 7 to 10

Lithium secondary battery cells were manufactured in the same manner as in Examples 5 to 8 respectively, except that the additive is changed to the compound represented by Chemical Formula b according to Comparative Preparation Example.

### EVALUATION OF BATTERY CELL CHARACTERISTICS

### Evaluation 1: Evaluation of Room Temperature Cycle-life Characteristics

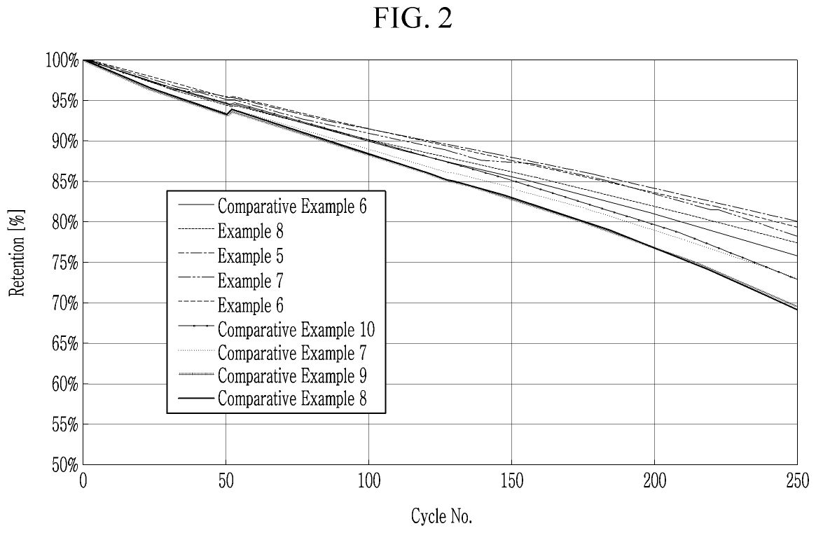

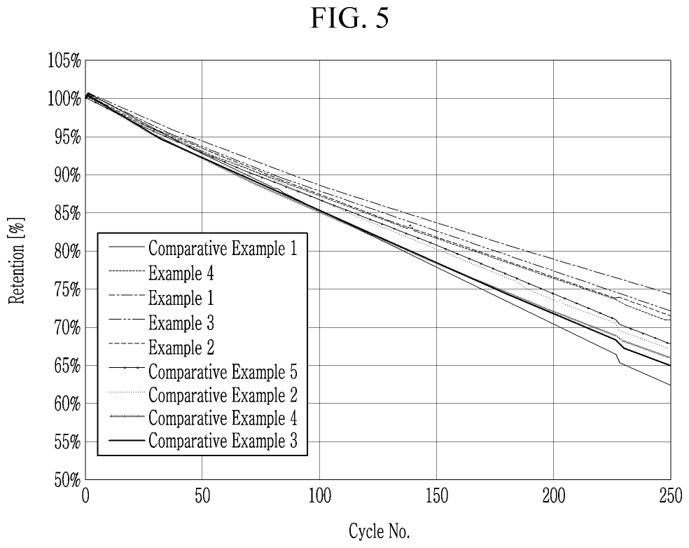

The secondary lithium battery cells according to Examples 1 to 8 and Comparative Examples 1 to 10 were charged at a constant current-constant voltage of 1.6 C and 4.2 V, cut off at 0.03 C, and discharged to 2.5 V at a constant current of 8 C at a room temperature (25° C.), and when 250 times charged and discharged, discharge capacity was measured, and then, capacity retentions of discharge capacity at the 200^{th} cycle relative to discharge capacity at the 1^{st} cycle were shown in FIGS. 2 and 5.

FIG. 2 is a graph showing cycle-life characteristics at room temperature (25° C.) of secondary battery cells according to Examples 5 to 8 and Comparative Examples 6 to 10.

FIG. 5 is a graph showing cycle-life characteristics at room temperature (25° C.) of secondary battery cells according to Examples 1 to 4 and Comparative Examples 1 to 5.

Referring to FIGS. 2 and 5, the secondary lithium battery cells of Examples 1 to 8 exhibited improved recovery capacity, compared with Comparative Examples 1 and 6 including no additive, and Comparative Examples 2 to 5 and 7 to 10 including the compound represented by Chemical Formula b as an additive.

In particular, as shown in FIG. 5, when the Si—C composite was included as a negative active material, the improvement effect was further increased.

In other words, Examples 1 to 8 according to the present invention exhibited excellent room temperature cycle-life characteristics compared with Comparative Examples 1 to 10, and accordingly, the secondary lithium battery cells including the compound represented by Chemical Formula 1 as an additive exhibited excellent cycle-life characteristics, and this improvement effect was much outstanding in Examples 1 to 4 including the Si—C composite as a negative active material.

### Evaluation 2: Evaluation of Direct Current-Internal Rsistance (DC-IR)

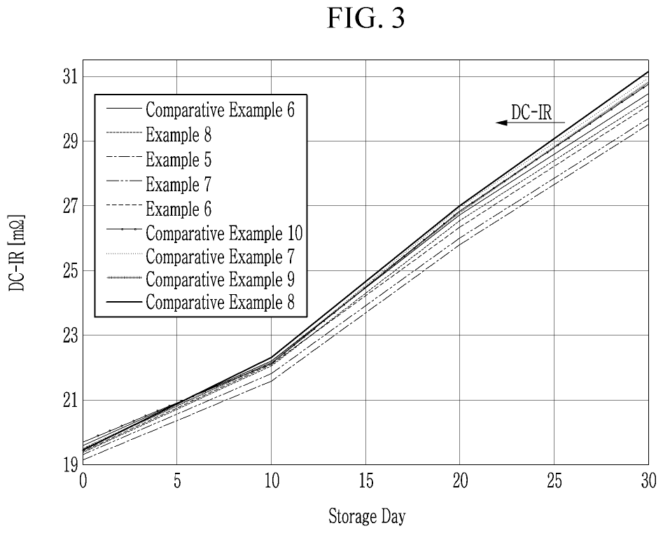

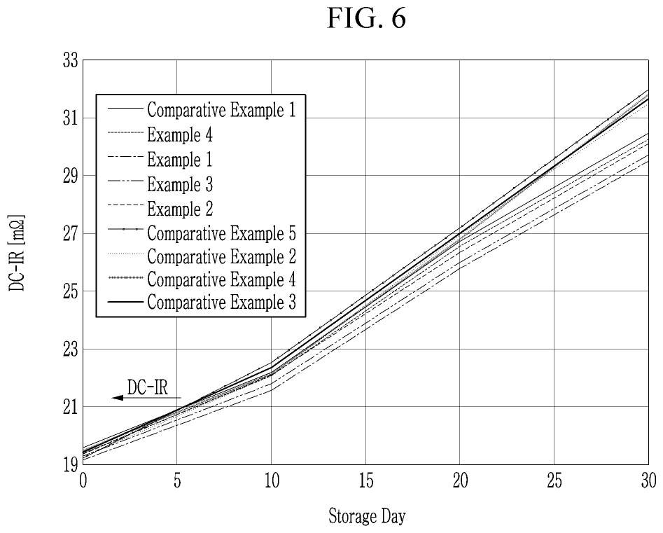

The secondary lithium battery cells of Examples 1 to 8 and Comparative Examples 1 to 10 were allowed to stand in a state of charge (SOC=100%) at 60° C. for 30 days and then, evaluated with respect to an internal resistance increase rate at a high temperature (60° C.), and the results are shown in FIGS. 3 and 6.

DC-IR was measured in the following method.

The cells according to Examples 1 to 8 and Comparative Examples 1 to 10 were charged at 4 A (1.6 C) and 4.2 V and cut off at a current of 75 mA, when a constant voltage of 4.2 V was applied thereto at room temperature (25° C.), and then, paused for 30 minutes. Subsequently, the cells were discharged at 10 A for 10 seconds, at 1 A for 10 seconds, and at 10 A for 4 seconds, respectively and then, measured with respect to a current and a voltage at 18 seconds and 23 seconds, which were used to calculate initial resistance (a difference between resistance at 18 seconds and resistance at the 23 seconds) according to ΔR=ΔV/ΔI. The cells were charged under the above buffering charge conditions, allowed to stand at 60° C. for 30 days and then, measured with respect to DC-IR, which was used to calculate and a resistance increase rate before and after allowed to stand according to Equation 1.

<Equation 1>

Resistance increase rate=[(DC-IR after being allowed to stand for 30 days−initial DC-IR)/initial DC-IR]×100

FIG. 3 is a graph showing an internal resistance increase rate of secondary battery cells according to Examples 5 to 8 and Comparative Examples 6 to 10 when allowed to stand at a high temperature.

FIG. 6 is a graph illustrating an internal resistance increase rate of secondary battery cells according to Examples 1 to 4 and Comparative Examples 1 to 5 when allowed to stand at a high temperature.

Referring to FIGS. 3 and 6, the secondary battery cells of Example 1 to 8 exhibited greatly deteriorated resistance increase rates before and after allowed to stand at a high temperature, compared with Comparative Examples 1 to 10. As shown in FIG. 6, this slowing in the resistance increase was more outstanding in Examples 1 to 4 including the Si—C negative active material.

Accordingly, the secondary battery cells according to Examples 1 to 8 exhibited improved high temperature stability, compared with Comparative Examples 1 to 10.

### Evaluation 3: Evaluation of High-Temperature Storage Characteristics

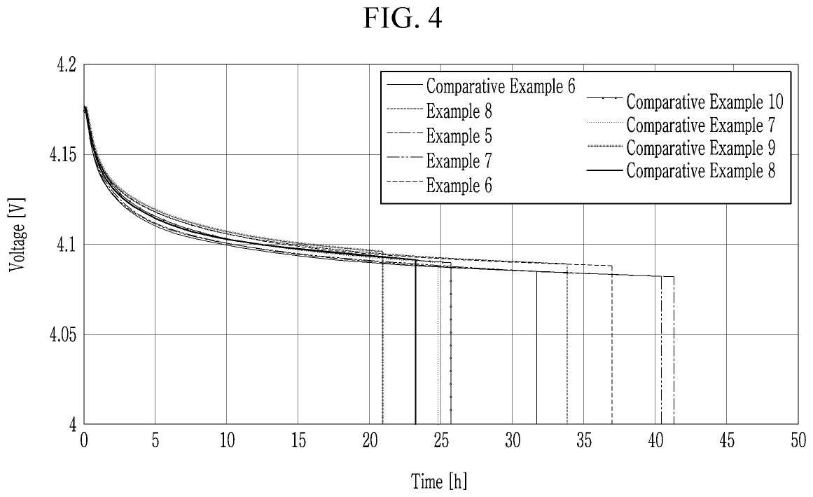

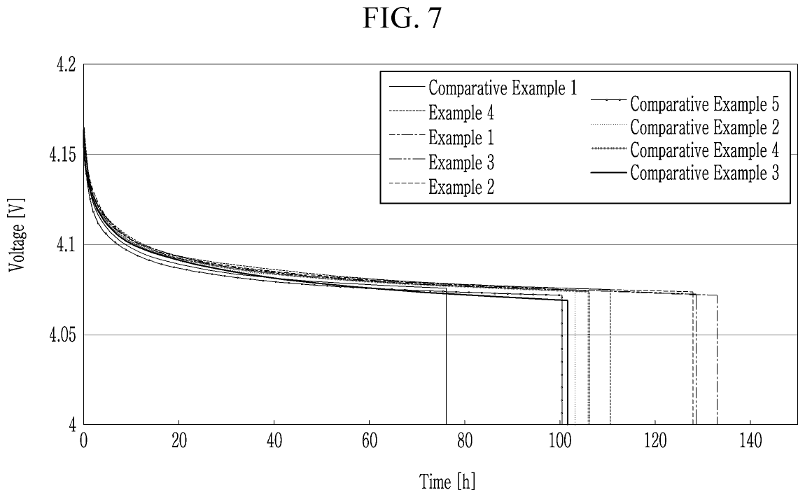

The secondary lithium battery cells were evaluated with respect to high-temperature storage characteristics by measuring CID operation time, and the results are shown in FIGS. 4 and 7.

The secondary battery cells of Examples 1 to 8 and Comparative Examples 1 to 10 were charged through multiple stages of 0.2 C→0.5 C→1.0 C and then, discharged at 0.5 C to perform formation charge/discharge. After additionally conducting one charge/discharge, the cells were buffered to 4.2 V and then, measured with respect to CID (Current Interrupt Device) operation time, while allowed to stand in a 90° C. chamber.

FIG. 4 is a graph of measuring the CID (Current Interrupt Device) operation time of the secondary battery cells according to Examples 5 to 8 and Comparative Examples 6 to 10.

FIG. 7 is a graph of measuring the CID (Current Interrupt Device) operation time of the secondary battery cells according to Examples 1 to 4 and Comparative Examples 1 to 5.

The current interrupt device (CID) is to detect internal pressure changes of the battery cells, and when the cells reached an internal pressure of a predetermined level or more, the CID was operated and halted the charges of the cells to prevent an overcharge.

Referring to FIG. 4, when stored at a high temperature of 90° C., Comparative Example 6 including no compound represented by Chemical Formula a as an additive exhibited a sharp voltage drop after 30 hours to 35 hours, Comparative Examples 7 to 10 including the compound represented by Chemical Formula b as an additive exhibited a rapid voltage drop before 30 hours, but Examples 5 to 8 including the compound represented by Chemical Formula a as an additive delayed decomposition of an electrolyte and slowed the resistance increase, which exhibited an effect of delaying the OCV drop.

In addition, referring to FIG. 7, when stored at a high-temperature of 90° C., Comparative Example 1 including no compound represented by Chemical Formula a as an additive exhibited a sharp voltage drop before 80 hours, Comparative Examples 2 to 5 including the compound represented by Chemical Formula b as an additive exhibited a sharp voltage drop after about 100 hours, but Examples 1 to 4 including the compound represented by Chemical Formula a as an additive delayed decomposition of an electrolyte and slowed the resistance increase, which exhibited an effect of delaying the OCV drop. In particular, as shown in FIG. 7, when the Si—C composite was included as a negative active material, the delay effect was much improved.

In other words, the secondary lithium battery cells according to the present invention exhibited excellent effects of suppressing gas generation during the high-temperature storage.

While this invention has been described in connection with what is presently considered to be practical example embodiments, it is to be understood that the invention is not limited to the disclosed embodiments. On the contrary, it is intended to cover various modifications and equivalent arrangements included within the spirit and scope of the appended claims.

1. An electrolyte for a secondary lithium battery, the electrolyte comprising:
a non-aqueous organic solvent,
a lithium salt, and
an additive,
wherein the additive includes a compound represented by Chemical Formula 1: 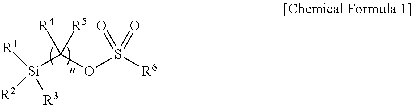
wherein, in Chemical Formula 1,
R¹ to R⁵ are each independently hydrogen, a halogen, a substituted or unsubstituted C1 to C10 alkyl group, a substituted or unsubstituted C1 to C10 alkoxy group, a substituted or unsubstituted C2 to C10 alkenyl group, a substituted or unsubstituted C3 to C10 cycloalkyl group, a substituted or unsubstituted C3 to C10 cycloalkenyl group, a substituted or unsubstituted C2 to C10 alkynyl group, a substituted or unsubstituted C3 to C10 cycloalkynyl group, or a substituted or unsubstituted C6 to C20 aryl group,
at least one of R¹ to R³ is a fluoro group (—F),
R⁶ is a substituted or unsubstituted C1 to C10 alkyl group, a substituted or unsubstituted C1 to C10 alkoxy group, a substituted or unsubstituted C2 to C10 alkenyl group, a substituted or unsubstituted C3 to C10 cycloalkyl group, a substituted or unsubstituted C3 to C10 cycloalkenyl group, a substituted or unsubstituted C2 to C10 alkynyl group, or a substituted or unsubstituted C3 to C10 cycloalkynyl group, and
n is an integer of 1 to 20.

2. The electrolyte for a secondary lithium battery of claim 1, wherein one or two of R¹ to R³ in Chemical Formula 1 are a fluoro group (—F).

3. The electrolyte for a secondary lithium battery of claim 1, wherein Chemical Formula 1 is represented by Chemical Formula 1A: 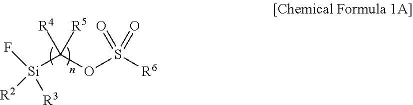
wherein, in Chemical Formula 1A, R² to R⁶ and n are defined the same as those of Chemical Formula 1.

4. The electrolyte for a secondary lithium battery of claim 1, wherein n is an integer of 1 to 10.

5. The electrolyte for a secondary lithium battery of claim 1, wherein n is an integer of 1 to 5.

6. The electrolyte for a secondary lithium battery of claim 1, wherein Chemical Formula 1 is represented by Chemical Formula 1A-1: 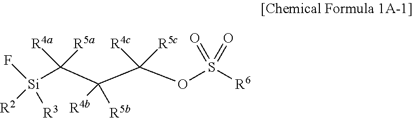
wherein, in Chemical Formula 1A-1,
R², R³, and R⁶ and n are defined the same as those of Chemical Formula 1, and
R^{4a}, R^{4b}, R^{4c}, R^{5a}, R^{5b}, and R^{5c} are each independently hydrogen, a halogen, a substituted or unsubstituted C1 to C10 alkyl group, a substituted or unsubstituted C1 to C10 alkoxy group, a substituted or unsubstituted C2 to C10 alkenyl group, a substituted or unsubstituted C3 to C10 cycloalkyl group, a substituted or unsubstituted C3 to C10 cycloalkenyl group, a substituted or unsubstituted C2 to C10 alkynyl group, a substituted or unsubstituted C3 to C10 cycloalkynyl group, or a substituted or unsubstituted C6 to C20 aryl group.

7. The electrolyte for a secondary lithium battery of claim 1, wherein:
R¹ to R³ and R⁶ are each independently a halogen, a substituted or unsubstituted C1 to C10 alkyl group, or a substituted or unsubstituted C2 to C5 alkenyl group, and
one of R¹ to R³ is a fluoro group (—F).

8. The electrolyte for a secondary lithium battery of claim 1, wherein the compound represented by Chemical Formula 1 is included in an amount of 0.1 wt % to 10 wt %, based on a total weight of the electrolyte for a lithium secondary battery.

9. The electrolyte for a secondary lithium battery of claim 1, wherein the compound represented by Chemical Formula 1 is included in an amount of 0.2 wt % to 2.0 wt %, based on a total weight of the electrolyte for a lithium secondary battery.

10. A secondary lithium battery, comprising:
a positive electrode including a positive active material;
a negative electrode including a negative active material; and
the electrolyte of claim 1.

11. The secondary lithium battery of claim 10, wherein the negative active material includes a Si—C composite including a Si-based active material and a carbon-based active material.

12. The secondary lithium battery of claim 11, wherein the negative active material further includes crystalline carbon.

13. The secondary lithium battery of claim 12, wherein:
the crystalline carbon includes graphite, and
the graphite includes natural graphite, artificial graphite, or a mixture thereof.

14. The secondary lithium battery of claim 11, wherein:
the Si—C composite further includes a shell surrounding the surface of the Si—C composite, and
the shell includes amorphous carbon.

15. The secondary lithium battery of claim 14, wherein the amorphous carbon includes soft carbon, hard carbon, a mesophase pitch carbonized product, calcined coke, or a mixture thereof.

16. The secondary lithium battery of claim 10, wherein the positive active material is a composite oxide of a nickel-containing metal and lithium.

17. The secondary lithium battery of claim 16, wherein:
the positive active material is represented by Chemical Formula 5:
[Chemical Formula 5]
LiₐM¹_{1-y1-z1}M²_{y1}M³_{z1}O₂
in Chemical Formula 5,
0.9≤a≤1.8, 0≤y1≤1, 0≤z1≤1, 0≤y1+z1<1, and
M¹, M², and M³ are each independently Ni, Co, Mn, Al, Sr, Mg, La, or a combination thereof.
